(19) United States
(12) Patent Application Publication
(10) Pub. No.: US 2007/0008229 A1
(43) Pub. Date: Jan. 11, 2007

(54) Electronic device utilizing global positioning system

(75) Inventors: Arthur Chang, Taipei (TW); Chang Jen Ho, Taipei (TW)

Correspondence Address: BIRCH STEWART KOLASCH & BIRCH, PO BOX 747, FALLS CHURCH, VA, 22040-0747, US

(73) Assignee: ASUSTeK COMPUTER INC.

(21) Appl. No.: 11/480,890

(22) Filed: Jul. 6, 2006

(30) Foreign Application Priority Data
Jul. 7, 2005 (TW) 94123040

(51) Int. Cl. H01Q 1/24

(52) U.S. Cl. 343/702

(57) ABSTRACT

An electronic device utilizing global positioning system (GPS) is provided. The electronic device includes a host, an antenna and a hinge. The hinge pivotally connects the host and the antenna for enabling the antenna to rotate around at least a first straight line and a second straight line as axes with respect to the host, or the hinge enables the antenna to rotate with respect to the host three-dimensionally.

This application claims the benefit of Taiwan application Serial No. 94123040, filed Jul. 7, 2005, the subject matter of which is incorporated herein by reference.

### BACKGROUND OF THE INVENTION

1. Field of the Invention

The invention relates in general to an electronic device utilizing global positioning system (GPS), and more particularly to an electronic device utilizing GPS whose antenna is capable of rotating three-dimensionally.

2. Description of the Related Art

A conventional electronic device utilizing global positioning system (GPS) includes a host, an antenna and a uniaxial hinge. The antenna is pivotally connected to the host via a uniaxial hinge, so that the conventional antenna can rotate around a straight line as the axis for enabling the antenna to be adjusted to an appropriate direction and angle capable of receiving a positioning signal transmitted by a satellite system.

When the electronic device utilizing GPS is installed in a vehicle, the driver can be informed of the current position by the electronic device utilizing GPS, which can further provide the driver with the route and navigation.

However, the best direction and angle of signal reception of an antenna may change when the electronic device is positioned in different places. Moreover, the conventional antenna can only rotate around a straight line as the axis with respect to the host, so that the movements and directions of the antenna are severely restricted and that the driver may be unable to adjust the antenna to the best direction and angle of signal reception. Thus, the conventional electronic device utilizing GPS might have poor signal reception and fail to position the vehicle. Consequently, the positioning and navigating functions are incapacitated, severely affecting the practicality of the electronic device utilizing GPS.

### SUMMARY OF THE INVENTION

It is therefore an object of the invention to provide an electronic device utilizing global positioning system (GPS). The electronic device uses a hinge to pivotally connect the antenna and the host, so that the antenna rotates with respect to the host three-dimensionally to resolve the problem of poor signal reception of a conventional electronic device utilizing GPS whose antenna can only rotate around a straight line as the axis with respect to the host. Consequently, the direction and angle of signal reception of antenna are largely widened, and the practicality of the electronic device utilizing GPS is enhanced.

The invention achieves the above-identified object by providing an electronic device utilizing GPS. The electronic device includes a host, an antenna and a hinge. The hinge pivotally connects the host and the antenna for enabling the antenna to rotate around at least a first straight line and a second straight line as axes axes with respect to the host.

The invention achieves the above-identified object by providing another electronic device utilizing GPS. The electronic device includes a host, an antenna and a hinge. The hinge pivotally connects the host and the antenna for enabling the antenna to rotate with respect to the host three-dimensionally.

The antenna receives a positioning signal transmitted by a satellite system. The host includes a processing unit, a display panel and an operating interface. The processing unit is electrically connected to the antenna and receives a positioning signal to position a position of the electronic device. The display panel is electrically connected to the processing unit for displaying the position of the electronic device. The operating interface is electrically connected to the processing unit for a user to operate the electronic device.

The invention achieves the above-identified object by providing yet another electronic device utilizing GPS. The electronic device includes an antenna, a host and a hinge. The antenna receives a positioning signal transmitted by a satellite system. The host includes a processing unit, a display panel and an operating interface. The processing unit is electrically connected to the antenna and receives the positioning signal to position the electronic device. The display panel is electrically connected to the processing unit for displaying the position of the electronic device. The operating interface is electrically connected to the processing unit for a user to operate the electronic device. The hinge pivotally connects the host and the antenna for enabling the antenna to rotate around at least a first straight line and a second straight line as axes, or for enabling the antenna to rotate with respect to the host three-dimensionally.

Moreover, the aforementioned display panel includes a liquid crystal display panel (LCD panel), an organic light emitting display (OLED) or an organic electroluminescent device (OELD). Besides, the aforementioned operating interface includes several buttons or a touch pad.

Other objects, features, and advantages of the invention will become apparent from the following detailed description of the preferred but non-limiting embodiments. The following description is made with reference to the accompanying drawings.

### BRIEF DESCRIPTION OF THE DRAWINGS

FIGS. 1A-1B are two three-dimensional diagrams of the electronic device utilizing GPS according to the preferred embodiment of the invention; and

FIG. 2 is a block diagram of the electronic device utilizing GPS according to the preferred embodiment of the invention.

### DETAILED DESCRIPTION OF THE INVENTION

The electronic device utilizing GPS of the invention includes a host, an antenna and the hinge. The hinge pivotally connects the host and the antenna for enabling the antenna to rotate around at least a first straight line and a second straight line as axes, or enabling the antenna to rotate with respect to the host three-dimensionally.

The main concept of the invention is to pivotally connect the host and the antenna of the electronic device utilizing GPS by a hinge which can be rotated in three dimensions, so that the antenna rotates around at least a first straight line and a second straight lire as axes, largely increase the scope and range of movement of the antenna for enabling the antenna to receive a positioning signal transmitted by a satellite system in more directions and wider angles. By doing so, the invention resolve the problem of poor signal reception of the conventional electronic device utilizing GPS whose antenna can only rotate around a straight line as the axis. Embodiments of the electronic device utilizing GPS of the invention are exemplified below with accompanied drawings.

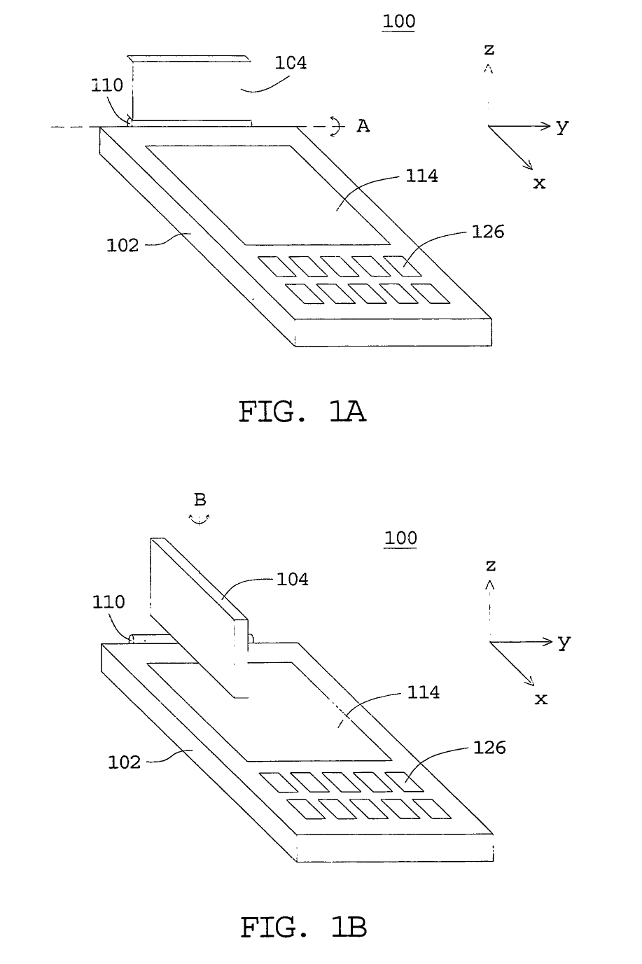

Referring to both FIGS. 1A˜1B, two three-dimensional diagrams of the electronic device utilizing GPS according to the preferred embodiment of the invention are shown. In FIGS. 1A˜1B, the electronic device utilizing GPS 100 includes a host 102, an antenna 104 and a hinge 110. The hinge 110 pivotally connects the host 102 and the antenna 104, so that the antenna 104 rotates with respect to the host 102 three-dimensionally, largely transcending the restraint imposed on the conventional antenna which can only rotate with respect to the host via a uniaxial hinge and enhancing the practicality of the electronic device utilizing GPS.

The antenna 104 rotate with respect to the host 102 using at least a first straight line A and a second straight line B as axes, largely increasing the range of movements and directions of the antenna 104. In the present embodiment, the first straight line A can be perpendicular to the second straight line B, and the first straight line A and the second straight line B are extended along the y direction and the z direction respectively. However, the first straight line A and the second straight line B of the present embodiment are not limited to the straight lines illustrated in FIG. 1A and FIG. 1B. Anyone who is skilled in the technology will understand that the present embodiment is merely an example according to the spirit of the invention.

However, anyone who is skilled in the technology of the embodiment of the invention will understand that the scope of technology of the embodiment of the invention is not limited thereto. For example, the aforementioned hinge 110 can include two uniaxial hinges pivotally connected to each other. One uniaxial hinge enables the antenna 104 to rotate with respect to the host 102 using the first straight line A as an axis, while another uniaxial hinge enables the antenna 104 to rotate with respect to the host 102 using the second straight line B as an axis. Moreover, the aforementioned hinge 110 can be a dual hinge or a triple hinge, which enables the antenna 104 to rotate with respect to the host 102 three-dimensionally. Any antenna of the electronic device utilizing GPS which enables the hinge to rotate with respect to the host in three dimensions is within the scope of protection of the invention.

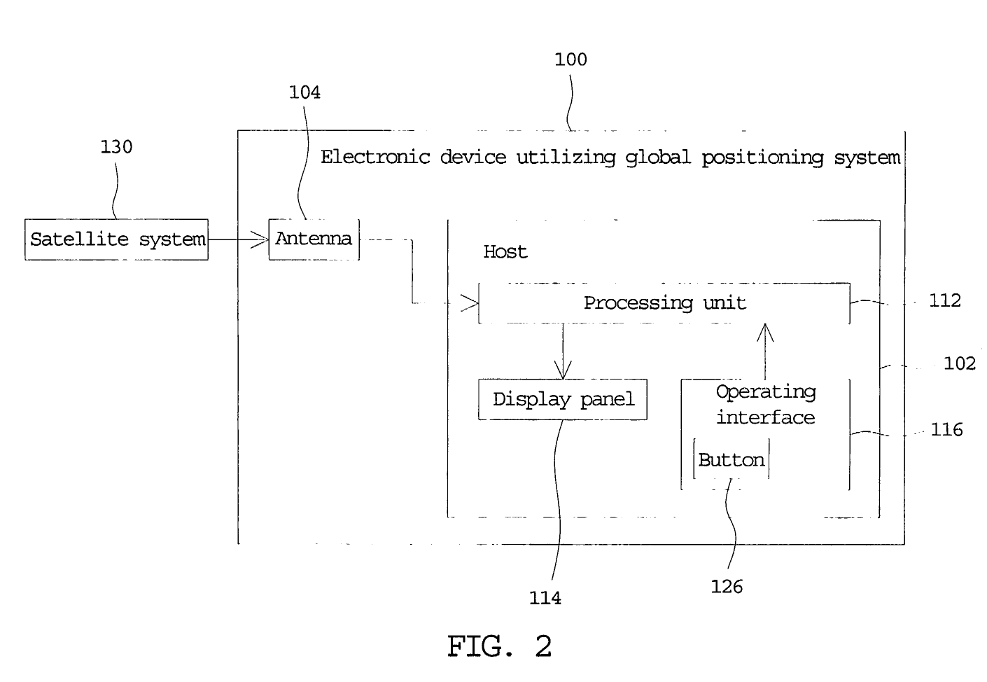

Referring to FIG. 2, a block diagram of the electronic device utilizing GPS according to the preferred embodiment of the invention is shown. Referring to FIGS. 1A˜1B, in the electronic device utilizing GPS 100 of the present embodiment, the antenna 104 is for receiving a positioning signal transmitted by the satellite system 130. The host 102 includes a processing unit 112, a display panel 114 and an operating interface 116. The processing unit 112 is electrically connected to the antenna 104 and receives the positioning signal to position the electronic device 100. The display panel 114 is electrically connected to the processing unit 112 for displaying the position of the electronic device 100. The operating interface 116 is electrically connected to the processing unit 112 for the user to operate with. The aforementioned operating interface 116 includes several buttons or a touch pad. In the present embodiment, the operating interface 126 is exemplified by several buttons 126. The user controls the electronic device 100 by operating the operating interface 126. For example, the electronic device 100 is controlled by pressing the button. The aforementioned display panel 114 includes a liquid crystal display panel (LCD panel), an organic light emitting display (OLED) or an organic electroluminescent device (OELD). Moreover, the host 102 can use a touch display panel to include the aforementioned display panel 114 and buttons 126.

The electronic device utilizing GPS of the present embodiment rotates with respect to the hinge three-dimensionally, so that the antenna rotates with respect to the host via the hinge using at least a first straight line and a second straight line as axes. By doing so, the problem of poor signal reception of a conventional electronic device utilizing GPS whose antenna is unable to receive signals from various directions is resolved, largely increasing the practicality of the electronic device utilizing GPS. Furthermore, the electronic device utilizing GPS of the present embodiment can also be installed in a vehicle to be used as a PocketPC or AutoPC electronic device utilizing GPS. Since the antenna of the present embodiment can be rotated with respect to the host three-dimensionally, the user can adjust the directions and angles of signal reception of the antenna according to the current location of the vehicle until the best direction and angle of signal reception are achieved. Therefore, the PocketPC electronic device utilizing GPS of the present embodiment can have better quality of signal reception to position the vehicle accordingly.

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. An electronic device utilizing global positioning system (GPS), comprising:
a host;
an antenna; and
a hinge pivotally connecting the host and the antenna for enabling the antenna to rotate around at least a first straight line and a second straight line as axes with respect to the host.

2. The electronic device according to claim 1, wherein the hinge comprises two uniaxial hinges.

3. The electronic device according to claim 1, wherein the hinge is a dual hinge.

4. The electronic device according to claim 1, wherein the first straight line is perpendicular to the second straight line.

5. The electronic device according to claim 1, wherein the hinge is a triple hinge.

6. The electronic device according to claim 1, wherein the antenna receives a positioning signal transmitted by a satellite system, and the host comprises:
a processing unit electrically connected to the antenna for receiving the positioning signal to position a position of the electronic device;
a display panel electrically connected to the processing unit for displaying the position; and
an operating interface electrically connected to the processing unit for a user to operate the electronic device.

7. The electronic device according to claim 6, wherein the operating interface comprises a plurality of buttons.

8. An electronic device utilizing global positioning system (GPS), comprising:
a host;
an antenna; and
a hinge pivotally connecting the host and the antenna for enabling the antenna to rotate with respect to the host three-dimensionally.

9. The electronic device according to claim 8, wherein the hinge comprises two uniaxial hinges.

10. The electronic device according to claim 8, wherein the hinge is a dual hinge.

11. The electronic device according to claim 8, wherein the antenna rotates around a first straight line and a second straight line as axes.

12. The electronic device according to claim 11, wherein the first straight line is perpendicular to the second straight line.

13. The electronic device according to claim 8, wherein the hinge is a triple hinge.

14. The electronic device according to claim 8, wherein the antenna receives a positioning signal transmitted by a satellite system, and the host comprises:
a processing unit electrically connected to the antenna for receiving the positioning signal to position a position of the electronic device;
a display panel electrically connected to the processing unit for displaying the position; and
an operating interface electrically connected to the processing unit for a user to operate the electronic device.

15. The electronic device according to claim 14, wherein the operating interface comprises a plurality of buttons.

16. An electronic device utilizing global positioning system (GPS), comprising:
an antenna for receiving a positioning signal transmitted by a satellite system;
a host, comprising:
a processing unit electrically connected to the antenna for receiving the positioning signal to position a position of the electronic device;
a display panel electrically connected to the processing unit for displaying the position; and
an operating interface electrically connected to the processing unit for a user to operate the electronic device; and
a hinge pivotally connecting the host and the antenna for enabling the antenna to rotate around at least a first straight line and a second straight line as axes with respect to the host, or for enabling the antenna to rotate with respect to the host three-dimensionally.

17. The electronic device according to claim 16, wherein the hinge comprises two uniaxial hinges.

18. The electronic device according to claim 16, wherein the hinge is a dual hinge or a triple hinge.

19. The electronic device according to claim 16, wherein the first straight line is perpendicular to the second straight line.

20. The electronic device according to claim 16, wherein the operating interface comprises a plurality of buttons.
